(19) United States
(12) Patent Application Publication
(10) Pub. No.: US 2008/0278040 A1
(43) Pub. Date: Nov. 13, 2008

(54) Air bypass system for biosafety cabinets

(76) Inventors: Larry A. McCarthy, Sanford, ME (US); Robert E. Lloyd, Kittery Point, ME (US); D. Aaron Johnson, Kennebunk, ME (US); Robert A. Thibeault, Sanford, ME (US); Martin S. Rogers, Saco, ME (US); Ronald W. Gingras, Sanford, ME (US)

Correspondence Address: LAHIVE & COCKFIELD, LLP;FLOOR 30, SUITE 3000, ONE POST OFFICE SQUARE, BOSTON, MA, 02109, US

(21) Appl. No.: 11/899,817

(22) Filed: Sep. 7, 2007

Related U.S. Application Data
(60) Provisional application No. 60/928,508, filed on May 10, 2007.

(51) Int. Cl. B08B 15/00; B01L 9/02; F24F 13/00; F24F 7/007

(52) U.S. Cl. 312/209; 454/195; 454/57

(57) ABSTRACT

A biosafety cabinet has an air bypass system. The air bypass system reduces air noise and static pressure in the biosafety cabinet, and continues a supply of air to the blower, when the view screen or door is fully closed by providing an alternate path for the air entering the cabinet. The air bypass system further includes an armrest provided on the door sill. The armrest may have perforations on the front and rear surfaces of the armrest to allow the air to travel under the armrest, through an air inlet. The air bypass system additionally blocks germicidal light generated inside the biosafety cabinet from escaping when the view screen or door is fully closed.

### RELATED APPLICATION

This application claims priority to, and the benefit of, co-pending U.S. Provisional Application No. 60/928,508, filed May 10, 2007, for all subject matter common to both applications. The disclosure of said provisional application is hereby incorporated by reference herein in its entirety.

### FIELD OF THE INVENTION

The present invention relates to biosafety cabinets, and more particularly a biosafety cabinet having an air bypass system that allows external air to enter the biosafety cabinet when the door of the biosafety cabinet is in a fully closed position.

### BACKGROUND OF THE INVENTION

A biosafety cabinet is a ventilated cabinet that uses a variety of combinations of air filters, unidirectional air flow, and containment to provide personnel, product, and cross contamination against particulates or aerosols from bio-hazardous agents. Conventional biosafety cabinets include one or more High Efficiency Particulate Arresting (HEPA) filters, although other types of air filters may be used as well. A HEPA filter is a type of air filter that can remove at least 99.97% of airborne particles down to 0.3 micrometres (μm) in diameter.

Typically, biosafety cabinets have an opening allowing the user to gain physical access to a working area or chamber within the cabinet. The user can close off the opening using a door, a panel, or the like, which is done for purposes of conducting experiments or some process within the cabinet that would emit hazardous byproducts or germicidal (ultraviolet) light. The door may include a sliding view screen, may be replaced by a sliding view screen, or may be of some other variation known to those of ordinary skill in the art. For purposes of consistency, the term “door” is used throughout the application to refer to all such variations. The door, panel, or the like, is often made of glass or some other substantially transparent material, and can form all or a portion of a substantially transparent panel referred to as a sliding view screen. A biosafety cabinet that is hard-ducted to an external exhaust system without any air bypass feature will often experience loud vibration or air noises around the sliding view screen and/or door when the door is fully closed. Such biosafety cabinets will also experience high exhaust negative static readings due to the physical resistance imposed on the airflow by the closed door. If the negative static pressure is large enough, it may become difficult or impossible to open the door once closed. Leaving the door slightly open reduces the imposed airflow resistance. However, doing so leaves an opening for hazardous agents and/or germicidal light generated inside the cabinet to escape. Hazardous agents escaping from the biosafety cabinet may be harmful to humans and/or the environment exposed to these agents.

One example of a cabinet that may address the problem of negative static pressure is found in U.S. Pat. No. 6,350,194 to Haugen et al. Haugen discusses providing vertical slots extending along the vertical height of the door of a biosafety cabinet. The outside air flows through the vertical slots into the interior cabinet. However, the outside air cannot be filtered before coming into contact with the interior cabinet because of the location of where it enters. Whatever particulates or contaminating elements that may be carried in the outside air are also introduced in the cabinet and as a result, the work environment and/or the experiment could be contaminated with unfiltered external air. In addition, there is no indication that germicidal light can be blocked from exiting the work environment through the vertical slots of Haugen.

### SUMMARY

In accordance with one embodiment of the present invention, an airflow bypass system includes a housing formed of a plurality of walls defining a chamber having an internal environment inside the chamber. A door is disposed on one wall of the housing having an open position and a closed position. The door provides physical access to the chamber when in the open position and obstructs access to the chamber when in the closed position. A door sill is disposed along an edge of the door against which the door mates when in the closed position. The airflow bypass system also includes an airflow bypass inlet disposed along the door sill providing an entrance to an airflow passage leading from an external environment outside of the chamber through to the internal environment when the door is in the closed position.

In accordance with variations of the present invention, the airflow bypass inlet disposed along a bottom edge of the door proximal to where the door mates with the door sill when in the closed position provides an entrance to an airflow passage leading from an external environment outside of the chamber through to the internal environment when the door is in the closed position.

In accordance with various aspects of the present invention, the door of the airflow bypass system includes a removable armrest. The armrest may include a removable pad attached to the top of the armrest. The airflow bypass system may also include an exhaust filter disposed to filter air exhausted from the chamber. The airflow bypass system may further include a supply filter disposed to filter airflow originating through the airflow bypass inlet.

In accordance with variations in the embodiments of the present invention, the door of the airflow bypass system may be slidably mounted within the housing. The airflow bypass system may further include a plurality of support structures supporting the door sill to maintain the airflow bypass inlet. The airflow bypass inlet includes a plurality of perforations that evenly disperse the air streams along the rows of perforations.

In accordance with variations in the embodiments of the present invention, the airflow bypass system can be a biosafety cabinet. The airflow bypass system may include a germicidal light source that generates germicidal light in the internal environment of the chamber. The airflow bypass inlet and airflow passage include a light occluding path configuration that prevents a substantial amount of germicidal light from escaping from the internal environment to the external environment while maintaining the airflow passage.

In accordance with variations in the embodiments of the present invention, the airflow bypass inlet and airflow passage may include a light occluding path configuration that allows only an amount of germicidal light less than an amount detrimental to humans to escape from the internal environment to the external environment while maintaining the airflow passage. In accordance with additional variations, the amount of germicidal light allowed to escape is below any safe threshold.

In accordance with aspects of the present invention, a method of introducing outside air into a biological safety cabinet includes providing a biological safety cabinet, positioning the door of the housing in the closed position and supplying air into the chamber of the biological safety cabinet through the sill bypass inlet from the external environment. The supply of air through the bypass inlet reduces static pressure in the chamber relative to static pressure in the chamber with the door in the closed position without a bypass inlet in operation. The supply of air through the bypass inlet further reduces air noise and/or vibration from the chamber relative to air noise and/or vibration from the chamber with the door in the closed position without a bypass inlet in operation.

### BRIEF DESCRIPTION OF THE DRAWINGS

The present invention will become better understood with reference to the following description and accompanying drawings, wherein:

FIG. 1A is a perspective view of a biosafety cabinet, in accordance with one embodiment of the present invention;

FIG. 1B is a front view of a biosafety cabinet, in accordance with one embodiment of the present invention;

FIG. 2A is a close-up cutaway view of the bottom of the biosafety cabinet's work area including a doorsill;

FIG. 2B is a close-up cutaway view of the bottom of the biosafety cabinet including a blower illustrating the airflow inside of the biosafety cabinet;

FIG. 3 is a side cutaway view of the biosafety cabinet illustrating the airflow inside of the biosafety cabinet; and

FIG. 4 is a flowchart illustrating a method of providing air from the external environment to inside of the biosafety cabinet.

### DETAILED DESCRIPTION

An illustrative embodiment of the present invention relates to a biosafety cabinet having an air bypass system. The air bypass system reduces air noise and static pressure in the biosafety cabinet when the sliding view screen or door of the cabinet is fully closed by providing an alternate path for air to enter the cabinet. An illustrative embodiment of the present invention introduces a space between the door sill and the edge of the work access opening of the cabinet. The illustrative embodiment may further include an armrest provided across the door sill. The armrest and/or the sill may have perforations on the front and rear surfaces of the armrest to allow the air to travel under the armrest, while providing coarse filtering to prevent large objects from falling into the inlet to the air passageway. The air bypass system further can provide blocking of germicidal light generated inside the biosafety cabinet from escaping when the view screen or door is fully closed.

The present invention differs from conventional devices that have no mechanism for allowing air into the cabinet when the view screen is closed, devices that teach a configuration that does not have the ability to achieve the same level of safety and containment, and/or devices whose solution does not address capability of providing filtered air versus non-filtered air to the work space within the cabinet. Past attempts, therefore, provide solutions that teach away from the configuration discussed herein. Accordingly, there is a need for a biosafety cabinet that allows outside air to enter into the work space of the biosafety cabinet in a manner that can be filtered and that can also prevent hazardous agents or detrimental amounts of hazardous light escape from the cabinet. The present invention addresses this need, in addition to having other characteristics.

Prior to discussing the details of the invention, a brief overview of the different biosafety cabinets will be provided. A biological safety cabinet is designed to reduce the potential escape of airborne research or experimental materials and byproducts into the worker's environment and to remove contaminants from air entering the research work zone. A laminar flow biological safety cabinet is designed to provide three basic types of protection: personnel protection from harmful agents inside the cabinet, product protection to avoid contamination of the work, experiment or process, and environmental protection from contaminants contained within the cabinet. In addition, the cabinet will provide cross contamination protection in the work zone to prevent airborne particles from traveling from one side of the cabinet to the other side of the cabinet.

Over the years, the scientific community has adopted commonly accepted classification criteria to differentiate containment capabilities and performance attributes of biological safety cabinets. In general, biological safety cabinets are divided into 3 classifications as illustrated in Table 1.

TABLE 1

| Classification | Biosafety Level | Application |
|---|---|---|
| Class I | 1, 2, 3 | low to moderate risk biological agents |
| Class II | 1, 2, 3 | low to moderate risk biological agents |
| Class III | 4 | high risk biological agents |

Biosafety Level 1 encompasses practices, safety equipment and facilities appropriate for work with defined and characterized strains of viable microorganisms not known to cause disease in healthy adult humans. Work is generally conducted on open bench tops using standard microbiological practices. For biosafety level 1, special containment equipment or facility design is neither required nor generally used.

Biosafety Level 2 encompasses practices, safety equipment and facilities appropriate for work done with a broad spectrum of indigenous moderate-risk agents present in the community and associated with human disease in varying severity. It differs from biosafety level 1 in that laboratory personnel have specific training in handling pathogenic agents and are directed by competent scientists; access to the laboratory is limited when work is being conducted; extreme precautions are taken with contaminated sharp items; and certain procedures in which infectious aerosols or splashes may be created are conducted in biosafety cabinets or other physical containment equipment. A Class I or Class II biosafety cabinet is recommended for work involving these agents.

Biosafety Level 3 encompasses practices, safety equipment and facilities appropriate for work done with indigenous or exotic agents with a potential for respiratory transmission which may cause serious and potentially lethal infection. More emphasis is placed on primary and secondary barriers to protect personnel in the contagious area, the community, and the environment from exposure to potentially infectious aerosols. A Class I or Class II biosafety cabinet is required for work involving these agents.

Biosafety Level 4 encompasses practices, safety equipment and facilities appropriate for work done with dangerous and exotic agents which pose a high risk of life threatening disease. Agents may be transmitted via the aerosol route, and for which there is no available vaccine or therapy. Access to the laboratory is strictly controlled by the laboratory director. The facility is either in a separate building or in a controlled area within a building, which is completely isolated from all other areas of the building. A Class III biosafety cabinet or pressurized environmental suits is required for work involving these agents.

The Class I cabinet has the most basic and rudimentary design of all biosafety cabinets. A stream of inward air moving into the cabinet contains aerosols generated during microbiological manipulations. It then passes through a filtration system that traps all airborne particles and contaminants. Finally, clean, filtered air is exhausted from the cabinet. The filtration system usually consists of a pre-filter and a HEPA (High Efficiency Particulate Air) filter.

Although the Class I cabinet protects the operator and the environment from exposure to biohazards, it does not prevent samples being handled in the cabinet from coming into contact with airborne contaminants that may be present in room air. Naturally, there is a possibility of cross-contamination that may affect experimental consistency. Class I biosafety cabinets are suitable for work with microbiological agents assigned to biological safety levels 1, 2 and 3.

Like Class I biosafety cabinets, Class II biosafety cabinets have a stream of inward air moving into the cabinet. This is known as the inflow and it prevents the aerosol generated during microbiological manipulations to escape through the front opening. However, unlike Class I cabinets, the inflow on Class II cabinets flows through the front inlet grille, near the operator. None of the unfiltered inflow air enters the work zone of the cabinet, so the product inside the work zone is not contaminated by the outside air.

A feature unique to Class II cabinets is a vertical laminar (unidirectional) HEPA-filtered air stream that descends downward from the interior of the cabinet. This continuously flushes the cabinet interior of airborne contaminants and protects samples being handled within the cabinet from contamination and is known as the down flow. Some cabinets may exhaust air directly back to the laboratory, while others may exhaust air through a dedicated ductwork system to the external environment.

Class II cabinets, like Class I cabinets, protect both the operator and environment from exposure to biohazards. In addition, Class II cabinets also protect product samples from contamination during microbiological manipulations within the cabinet interior and are all suitable for work with agents assigned to biological safety levels 1, 2 and 3. Class II cabinets are further classified according to how they exhaust air.

The Class II Type A biosafety cabinets exhaust air directly back to the laboratory, and they may contain positive pressure contaminated plenums. When toxic chemicals must be employed as an adjunct to microbiological processes, these cabinets are not used. Exhaust HEPA filtration only removes airborne aerosols including biohazards, and not chemical fumes.

The main difference between Class II type A and type B cabinets is that the type B cabinets must be operated with an external blower and it exhausts air to the external environment via a dedicated ductwork system. Without the external blower, the cabinet's internal blower will blow the air (and microbiological agents) inside the work zone through the front operator, towards the operators face, creating a dangerous situation.

The Class II Type B1 biosafety cabinets have a dedicated exhaust feature that eliminates re-circulation when work is performed towards the back within the interior of the cabinet.

In the Class II Type B2 cabinet all inflow and down flow air is exhausted after HEPA filtration to the external environment without recirculation within the cabinet. Type B2 cabinets are suitable for work with toxic chemicals employed as an adjunct to microbiological processes under all circumstances since no re-circulation occurs.

The Class III biosafety cabinet provides an absolute level of safety, which cannot be attained with Class I and Class II cabinets. Class III cabinets are usually of welded metal construction and are designed to be gastight. Work is performed through glove ports in the front of the cabinet. During routine operation, negative pressure relative to the ambient environment is maintained within the cabinet. This provides an additional fail-safe mechanism in case physical containment is compromised.

On Class III cabinets, a supply of HEPA filtered air provides product protection and prevents cross contamination of samples. Double HEPA filtered exhaust air may be incinerated. Class III cabinets exhaust air via a dedicated ductwork system to the external environment. When a dedicated ductwork system is employed, they are also suitable for work employing toxic chemicals as an adjunct to microbiological processes. Class III biosafety cabinets are frequently specified for work involving the most lethal biological hazards.

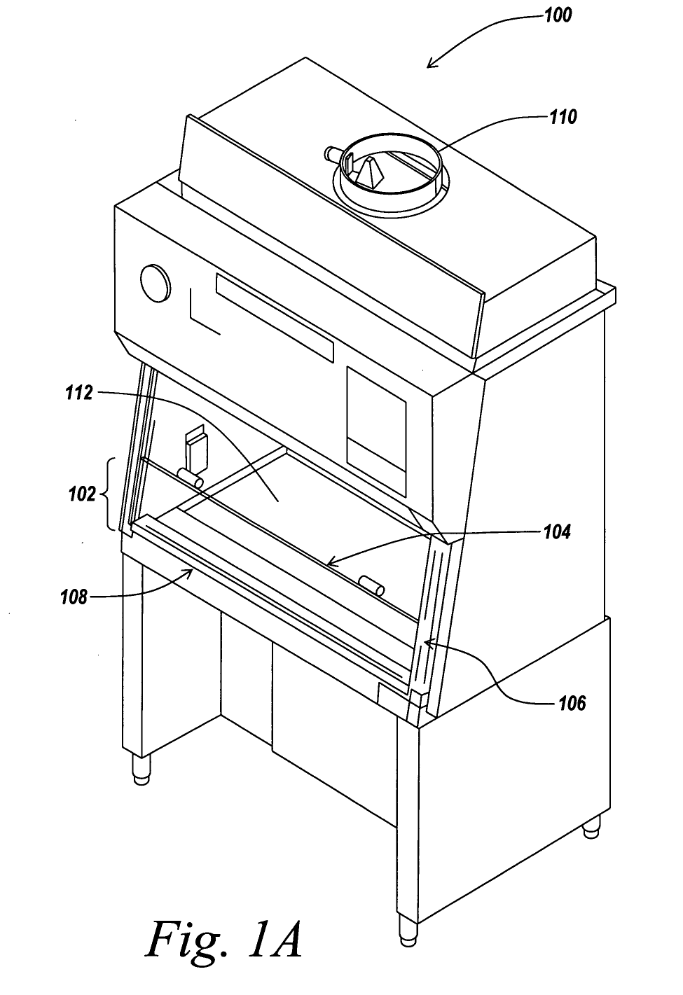

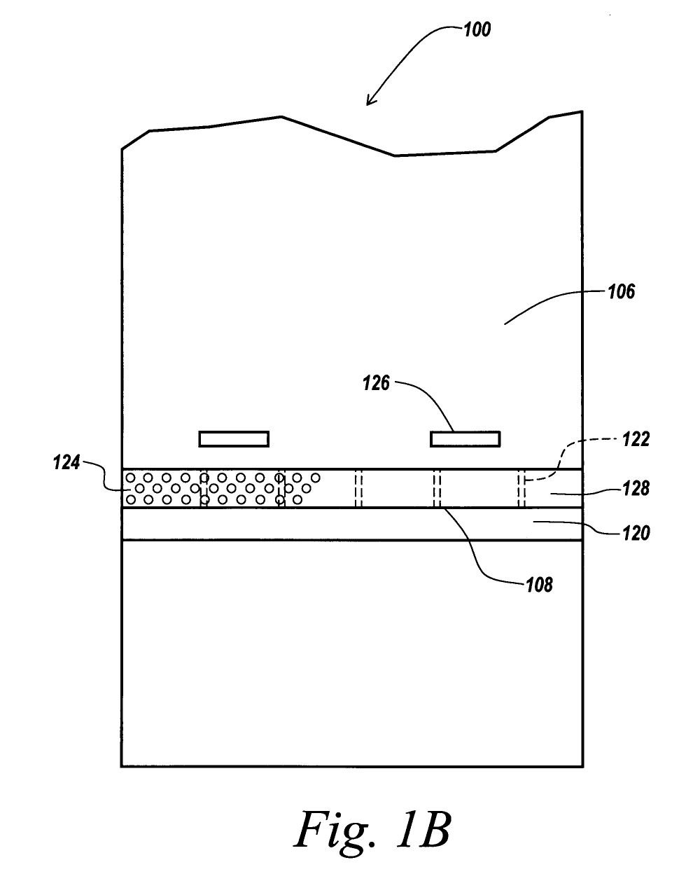

Now turning to the present invention, FIGS. 1A through 4, wherein like parts are designated by like reference numerals throughout, illustrate an example embodiment of a biosafety cabinet with an air bypass system in accordance with the present invention. Although the present invention will be described with reference to the example embodiment illustrated in the figures, it should be understood that many alternative forms can embody the present invention. One of ordinary skill in the art will additionally appreciate different ways to alter the parameters of the embodiment disclosed, such as the size, shape, or type of elements or materials, in a manner still in keeping with the spirit and scope of the present invention. The airflow bypass system described herein is not intended solely for use in Class II, Type B1 cabinets as illustrated but can also be used in any type of Class II biosafety cabinets.

FIG. 1A illustrates a biosafety cabinet 100 in accordance with one embodiment of the present invention. The biosafety cabinet 100 has a view screen 104 and a work access opening 102 provided below the view screen 104. According to requirements of specific embodiments, the view screen 104 may be a sliding view screen. A door 106 is provided in the view screen 104 area and may itself be a sliding view screen or may be a component of or within the view screen. When the door 106 is open, the user gains physical access to a work area 112 through the work access opening 102. A door sill 108 is provided below the door 106 along a bottom edge of the work access opening 102. The door sill includes an airflow bypass inlet 128. The external air passes through inlet 128 from an external environment outside of the cabinet 100 to the internal environment of the cabinet 100 even when the door 106 is closed. The airflow bypass inlet 128 can reduce the air noise, vibration, and the static pressure inside of the biosafety cabinet 100 when the biosafety cabinet's view screen 104 and the door 106 are fully closed and air is being pumped through the biosafety cabinet 100. The door sill 108 itself, along with the pathway back to the internal work environment, presents a physical barrier to the germicidal light provided inside of the biosafety cabinet 100. The germicidal light may customarily be automatically turned off when the view screen 104 or the door 106 of the biosafety cabinet 100 is opened. The door sill 108 and the configuration of the airflow bypass inlet 128 blocks the light from leaving the biosafety cabinet 100 at a level that could be harmful to humans and the environment. For example, occupational exposure limits recommended by the American Conference of Government Industrial Hygienists are: for the UV-A or near ultraviolet spectral region (315 to 400 nm), exposure to the eye should not exceed 1.0 mW/cm² for periods greater than 1000 seconds. For exposure times less than 1000 seconds, the dose exposed should not exceed 1.0 J/cm². For actinic ultraviolet spectral region (200-315 nm, about half of the UV-C and most of the UV-B range), the exposure of the unprotected skin or eye should not exceed the values given in Table-2 within an 8-hour period.

TABLE 2

| Wavelength (nm) | Threshold Limit Value (mJ/cm²) |
|---|---|
| 200 | 100 |
| 210 | 40 |
| 220 | 25 |
| 230 | 16 |
| 240 | 10 |
| 250 | 7 |
| 254 | 6.0 |
| 260 | 4.6 |
| 270 | 3.0 |
| 280 | 3.4 |
| 290 | 4.7 |
| 300 | 10 |
| 305 | 50 |
| 310 | 200 |
| 315 | 1000 |

The biosafety cabinet 100 further includes an exhaust system 110 to exhaust the contaminated air outside of the biosafety cabinet 100. The exhaust system 110 may include a HEPA filter.

FIG. 1B illustrates the front view of a biosafety cabinet 100 in accordance with the present invention. As illustrated in FIG. 1B, the door 106 is fully closed. The door sill 108 provided below the door 106 contains perforations 124 that allow the external air to travel through the inlet 128 of the door sill 108. The door sill 108 is supported by multiple support structures 122 that are securely attached to the bottom of the sill. The support structures 122 may be equally shaped and spaced to provide adequate support for the door sill 108, or they can be spaced at different intervals. A support 120 is provided to reinforce the biosafety cabinet 100.

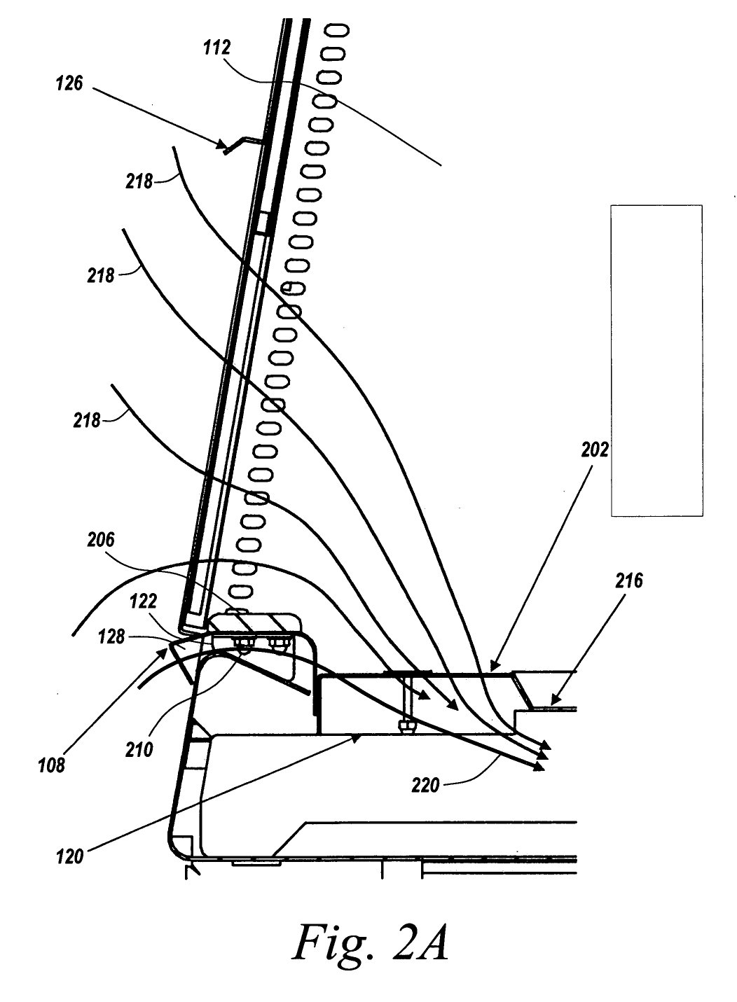

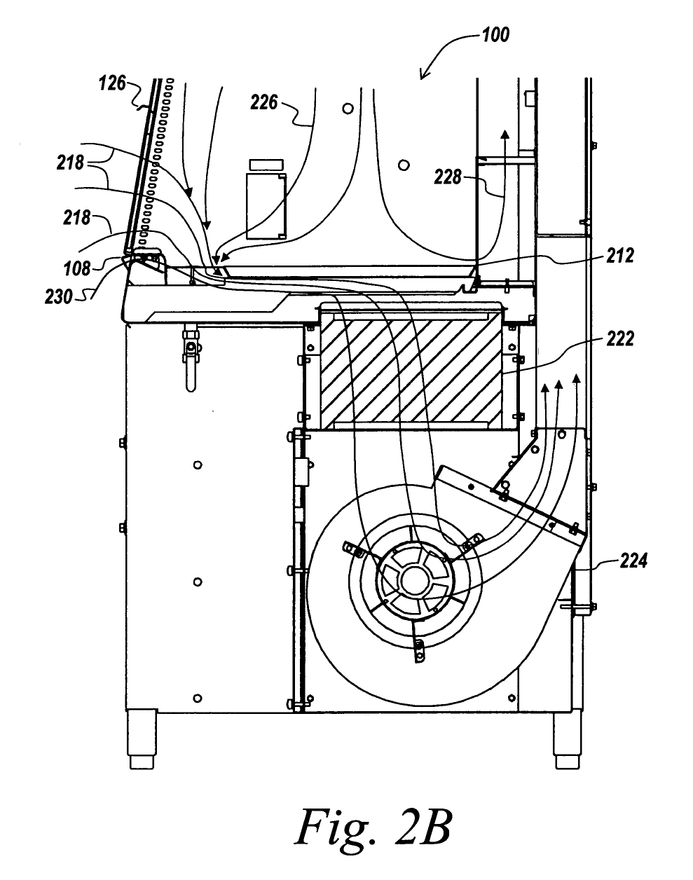

FIG. 2A illustrates a cutaway view of the bottom of the work area 112 of the biosafety cabinet. An armrest pad 206 is provided on the door sill 108 to provide user comfort and ease of cleaning and/or replacement. Users may rest their arms on the armrest pad 206 while working at the biosafety cabinet 100, thus reducing arm stress and fatigue. The armrest pad 206 has smooth surfaces and may be held in place using low tack double sided tape, or other conventional fastening technology. The armrest pad 206 may be easily removed, cleaned and replaced. According to an illustrative embodiment, the armrest pad 206 may be of dimensions ⅜″H×2″W×46″L. The armrest pad 206 may be made of closed cell Ethylene Propylene Diene Monomer (EPDM) sponge extrusion that is skinned smooth on all sides. The dimensions and the material indicated here are for illustrative purposes only and should not be construed as limiting. It would be obvious to one skilled in the art that the armrest pad may be of different dimensions and different materials that may or may not have similar properties.

According to an illustrative embodiment of the present invention, the door sill 108 can be constructed of 18 gauge stainless steel sheet metal that is punched and bent to form the door sill 108. The door sill 108 may further have support structures 122 that are made of, for example, 16 gauge stainless steel sheet metal punched and bent. Each support structure 122 may be attached to the bottom of the door sill 108 using weld studs, flat washers, and locking hex nut with vinyl caps 210, or by other conventional fastening means. The support structures 122 provide adequate support and even gapping between the door sill 108 and the bottom of the biosafety cabinet's work access opening 102.

According to an illustrative embodiment of the present invention, the door sill 108 may further have perforations 124 in the front and rear surfaces that allow external air to pass through. The work surface 216 may also have front perforations 202. The work surface 216 sets on the supports 120.

FIG. 2A further illustrates inlet airflow streams 218 and bypass airflow stream 220. As illustrated in FIG. 2A, the inlet airflow streams 218 enter the work area 112 through the work access opening 102 and travel below the work surface 216. The bypass airflow stream 220 enters the biosafety cabinet 100 through the inlet 128 of the door sill 108. The bypass airflow stream 220 does not travel directly to the work area 112. Instead, the bypass airflow stream 220 travels below the work surface 216, and is filtered prior to being introduced to the work area 112. As such, the external air is not introduced directly in the work area 112. This avoids the potential for contamination of the air at the location of the work or the experiment by unfiltered room air.

More specifically, FIG. 2B is a close-up cutaway view of the bottom of the biosafety cabinet including a blower that illustrates airflow streams inside the biosafety cabinet 100. The inlet airflow streams 218 enter though the work access opening 102 when the door 106 is open (as indicated in FIG. 2B with the door handles 126 being away from the door sill 108). The inlet airflow streams 218 and the bypass airflow stream 220 entering through the inlet 128 of the door sill 108 travel below the working surface 216 along with the contaminated air 226 from inside of the working area 112. The inlet airflow streams 218, the bypass airflow stream 220 and the contaminated air 226 move toward the down flow air filter 222. The bypass airflow stream 220 follows an airflow passage 230 that leads the bypass airflow stream 220 from the inlet 128 toward the down air filter 222 and to the blower 224. This way, the bypass airflow stream 220 gets filtered before contacting the working area 112. The down flow air filter 222 may be a High Efficiency Particulate Arresting (HEPA) filter. Some of the contaminated air 228 from inside of the working area 112 is directed toward the exhaust system 110 of the biosafety cabinet 100. The exhaust system 110 may include a HEPA filter. After passing through the down flow air filter 222, the inlet airflow stream 218, the bypass airflow stream 220 and filtered (formerly contaminated) air 226 are blown toward the ceiling of the biosafety cabinet 100 using a blower 224.

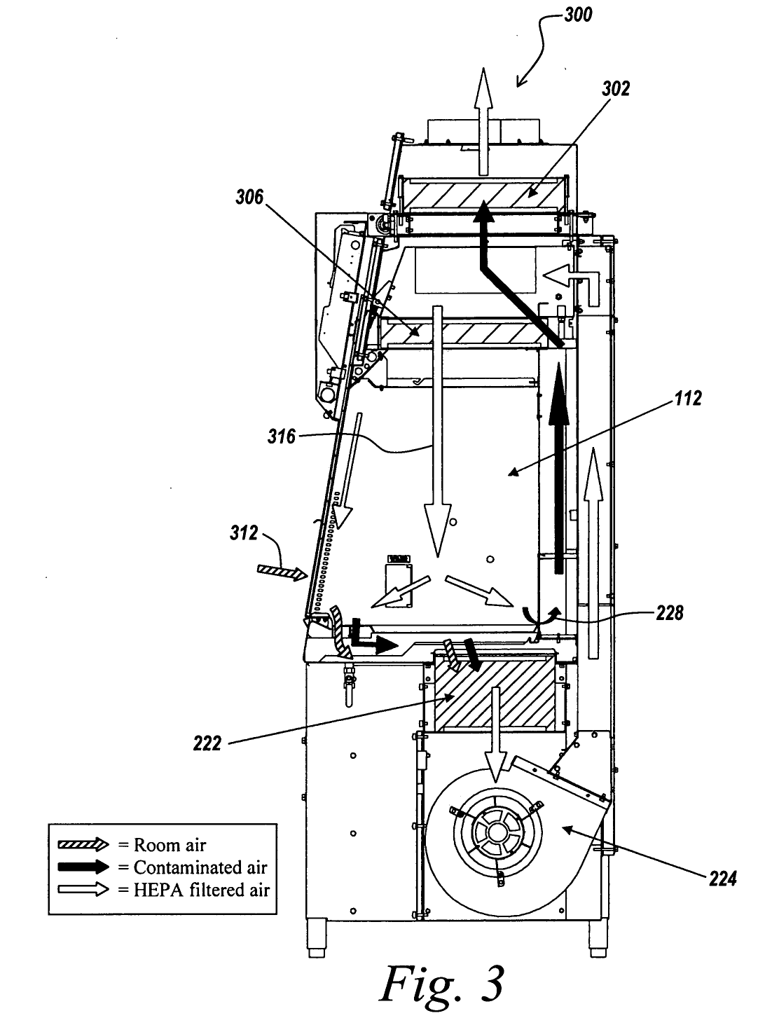

Unlike other known devices, the present invention can eliminate or significantly reduce the air noise and the static pressure inside the biosafety cabinet while also offering the capability to avoid contaminating the work area with unfiltered external air. As indicated above, according to an illustrative embodiment of the present invention, the external air enters the biosafety cabinet 100 through door sill 108, passes through the inlet 128 and follows the airflow passage 230. The airflow passage 230 directs the bypass airflow stream 220 toward the down flow air filter 222 without entering the working area 112. The external air gets filtered and blown toward the ceiling of the biosafety cabinet 100 through a blower 224. Upon reaching the ceiling, the external air may alternatively travel through a second air filter 306 before entering the working area 112, completing the airflow passage 230 from the external environment, through the inlet 128, to the work area. FIG. 3 illustrates airflows within the biosafety cabinet 100.

As illustrated in FIG. 3, upon reaching the ceiling, the filtered air 316 enters the working area 112 after passing through another air filter 306. Contaminated air 228 is exhausted to the exhaust system 110 of the biosafety cabinet 100 after passing through an air filter 302.

When the door 106 of the biosafety cabinet 100 is closed, the inlet airflow streams 218 no longer enter the biosafety cabinet 100. However, the bypass airflow stream 220 continues to enter through the inlet 128 of the door sill 108. The bypass airflow stream 220 and the contaminated air 226 move toward the down flow air filter 222, which may be a High Efficiency Particulate Arresting (HEPA) filter, or some other type of filter, as desired. Some of the contaminated air 228 from inside of the working area 112 is directed toward the exhaust system 110 of the biosafety cabinet 100. After passing through the down flow air filter 222, the bypass airflow stream 220 and filtered (formerly contaminated) air 226 are blown toward the ceiling of the biosafety cabinet 100 using a blower 224.

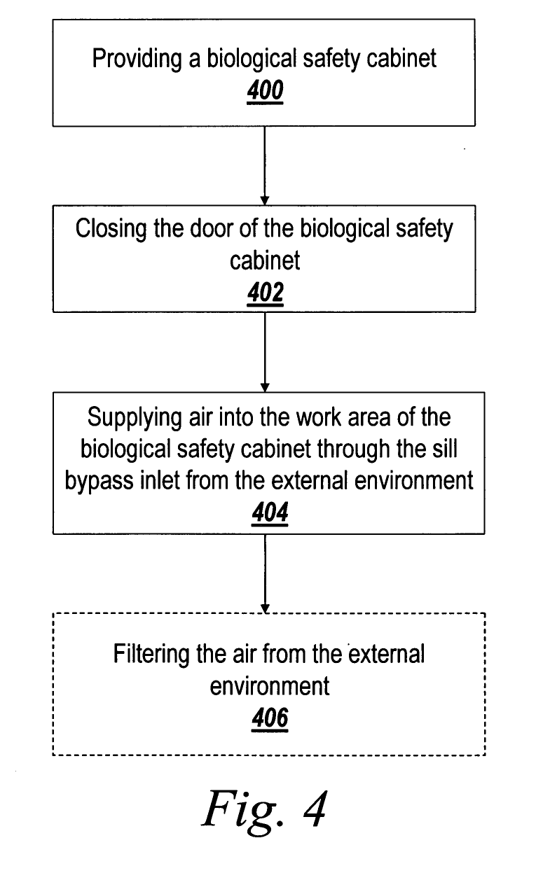

In operation, a method of providing air from the external environment to inside of the biosafety cabinet can occur as illustrated in FIG. 4 and discussed below. A biosafety cabinet is provided in step 400. The user fully closes the biosafety cabinet's door (step 402). External or room air is supplied into the working area of the biosafety cabinet through the door sill bypass inlet (step 404). The method further includes an optional step of filtering the air from the external environment (step 406). Supplying the external air inside of the biosafety cabinet reduces air noise and static pressure and blocks germicidal light in the biosafety cabinet when the view screen and/or the door is fully closed.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved.

What is claimed is:

1. An airflow bypass system, comprising:
a housing formed of a plurality of walls defining a chamber having an internal environment inside the chamber;
a door disposed on one wall of the housing having an open position and a closed position, the door providing physical access to the chamber when in the open position and obstructing access to the chamber when in the closed position;
a door sill disposed along an edge of the door against which the door mates when in the closed position; and
an airflow bypass inlet disposed along the door sill providing an entrance to an airflow passage leading from an external environment outside of the chamber through to the internal environment when the door is in the closed position.

2. The airflow bypass system of claim 1, wherein the door comprises a sliding visibility screen.

3. The airflow bypass system of claim 1, wherein the door sill further comprises an armrest.

4. The airflow bypass system of claim 3, further comprising a removable pad attached to the top of the armrest.

5. The airflow bypass system of claim 1, further comprising a plurality of support structures supporting the door sill to maintain the airflow bypass inlet.

6. The airflow bypass system of claim 1, wherein the airflow bypass inlet further comprises a plurality of perforations evenly dispersing air streams that passes therethrough.

7. The airflow bypass system of claim 1, further comprising one or more filters disposed to filter air entering or leaving the chamber.

8. The airflow bypass system of claim 1, wherein the housing comprises a biological safety cabinet.

9. The airflow bypass system of claim 1, wherein the chamber further comprises a germicidal light source that generates germicidal light in the internal environment of the chamber.

10. The airflow bypass system of claim 9, wherein the airflow bypass inlet and airflow passage comprise a light occluding path configuration that allows only an amount of germicidal light less than an amount detrimental to humans to escape from the internal environment to the external environment while maintaining the airflow passage.

11. A biological safety cabinet, comprising:
a housing formed of a plurality of walls defining a chamber having an internal environment inside the chamber;
a door disposed on one wall of the housing having an open position and a closed position, and configured to provide a work access opening providing physical access to the chamber when the door is in the open position and obstruct the work access opening when the door in the closed position;
a door sill disposed along a bottom edge of the work access opening and configured to mate with the door when the door is in the closed position, obstructing the work access opening; and
a sill bypass inlet disposed between the sill and the housing, the sill bypass providing an airflow passage leading from an external environment outside of the chamber through to the internal environment when the door is in the closed position.

12. The biological safety cabinet of claim 11, wherein the door comprises a sliding visibility screen.

13. The biological safety cabinet of claim 11, wherein the door sill further comprises an armrest.

14. The biological safety cabinet of claim 13, further comprising a removable pad attached to the top of the armrest.

15. The biological safety cabinet of claim 11, further comprising a plurality of support structures supporting the door sill to maintain the airflow bypass inlet.

16. The biological safety cabinet of claim 11, wherein the airflow bypass inlet further comprises a plurality of perforations evenly dispersing air streams that passes therethrough.

17. The biological safety cabinet of claim 11, further comprising one or more filters to filter air entering or leaving the chamber.

18. The biological safety cabinet of claim 11, wherein the chamber further comprises a germicidal light source that generates germicidal light in the internal environment of the chamber.

19. The biological safety cabinet of claim 18, wherein the airflow bypass inlet and airflow passage comprise a light occluding path configuration that allows only an amount of germicidal light less than an amount detrimental to humans to escape from the internal environment to the external environment while maintaining the airflow passage.

20. A method of introducing outside air into a biological safety cabinet, the method comprising:
providing a biological safety cabinet, comprising:
a housing formed of a plurality of walls defining a chamber having an internal environment inside of the chamber;
a door disposed on one wall of the housing having an open position and a closed position, the door providing physical access to the chamber when in the open position and obstructing access to the chamber when in the closed position;
a door sill disposed along an edge of the door against which the door mates when in the closed position; and
an airflow bypass inlet disposed along the door sill providing an entrance to an airflow passage leading from an external environment outside of the chamber through to the internal environment when the door is in the closed position;
positioning the door of the housing in the closed position; and
supplying air into the chamber of the biological safety cabinet through the sill bypass inlet from the external environment.

21. The method of claim 20, wherein the supply of air through the bypass inlet reduces static pressure in the chamber relative to static pressure in the chamber with the door in the closed position without a bypass inlet in operation.

22. The method of claim 20, wherein the supply of air through the bypass inlet reduces air noise from the chamber relative to air noise from the chamber with the door in the closed position without a bypass inlet in operation.

23. The method of claim 20, further comprising filtering the air from the external environment using a down flow filter.

24. The method of claim 20, further comprising:
introducing germicidal light to the biological safety cabinet, wherein the door and the door sill prevent the germicidal light from leaving the biological safety cabinet when the door is fill closed.

25. An airflow bypass system, comprising:
a housing formed of a plurality of walls defining at least one chamber having an internal environment inside the chamber;
a door disposed on one wall of the housing having an open position and a closed position, the door providing physical access to the chamber when in the open position and obstructing access to the chamber when in the closed position;
a door sill disposed along an edge of the door against which the door mates when in the closed position;
an airflow bypass inlet disposed along a bottom edge of the door proximal to where the door mates with the door sill when in the closed position, the airflow bypass inlet providing an entrance to an airflow passage leading from an external environment outside of the chamber through to the internal environment when the door is in the closed position.
